(19) United States
(12) Patent Application Publication
(10) Pub. No.: US 2020/0157380 A1
(43) Pub. Date: May 21, 2020

(54) ICE-PHOBIC COATINGS

(71) Applicants: DOW GLOBAL TECHNOLOGIES LLC, Midland, MI (US); DOW SILICONES CORPORATION, Midland, MI (US)

(72) Inventors: Yu CHEN, Shanghai (CN); Xiaomei SONG, Shanghai (CN); Guodong SHEN, Shanghai (CN); Hongyu CHEN, Shanghai (CN)

(21) Appl. No.: 16/634,831

(22) PCT Filed: Jul. 31, 2017
(86) PCT No.: PCT/CN2017/095146

§ 371 Date: Jan. 28, 2020

(51) Int. Cl. C09D 183/04; C09D 5/00; C09D 7/40; B05D 3/02

(52) U.S. Cl. CPC C09D 183/04; B05D 3/0254; C09D 7/69; C09D 5/00

(57) ABSTRACT

A coating composition which provides a coating with a very low adhesion to ice is disclosed. The coating composition contains methylpolysiloxane resin and a lubricant package comprising two kinds of different siloxane fluids.

### CROSS-REFERENCE TO RELATED APPLICATIONS

This application is the National Stage of International Appl. No. PCT/CN2017/095146 filed on 31 Jul. 2017, the content of which is incorporated herein by reference.

### FIELD

The present invention relates generally to a coating composition which provides a coating with a very low adhesion to ice. The coating composition comprises methylpolysiloxane resin and a lubricant package comprising two kind of different siloxane fluids.

### INTRODUCTION

Icing (ice build-up on an article) in a cold environment causes problems for many applications, including rotors and blades of wind turbines, power lines, telecommunications, transportations, air crafts and housewares such as refrigerators, freezer box and ice tray. Such ice build-up may be removed by heating, by applying chemicals that reduce the melting point of ice, by applying a mechanical force or by occluding air to break the bonding between ice and the surface of an article. However, all of these methods have limitations and disadvantages. An alternative method to prevent ice build-up on an article is to protect the surface of the article with a coating that has a very low ice adhesion strength (i.e. ice barely adheres to the coating). Such coating is called as “ice-phobic coating”. Some prior art references disclose an ice-phobic coating on the surface of articles, for example, US2015/0361319A, WO2016/176350A, WO2015/119943A, U.S. Pat. No. 9,388,325B and US2010/0326699.

### SUMMARY

The present invention provides a coating composition which shows very low adhesion to ice.

One aspect of the invention relates to a coating composition comprising:
(A) 50 to 95 weight % of methylpolysiloxane resin,
(B) 10 to 50 weight % of silicone fluid mixture comprising a first silicone fluid and a second silicone fluid represented by the following formulas,
   (B-1) the first silicone fluid having the Formula (1)

R²O(Me₂SiO)ₙMe₂SiOR² Formula (1)
wherein Me is a methyl group, R² is a hydrogen atom or an alkyl group having 1 to 4 carbon atoms, n is a number from 100 to 300, and the viscosity of the first silicone fluid is 10,000 centistokes or more,
(B-2) the second silicone fluid having the Formula (2):

R³₃Si(OSiMe₂)ₘOSiR³₃ Formula (2)
wherein Me is a methyl group, R³ is an alkyl group having 1 to 3 carbon atoms, m is a number from 10 to 40, and the viscosity of the second silicone fluid is from 100 to 2,000 centistokes,
(C) 0.1 to 4 weight % of a catalyst and
(D) 50 to 90 weight % of solvent,
   wherein the weight ratio of the first silicone fluid over the second silicone fluid ((B-1)/(B-2)) is from 0.6 to 2.8.

In another aspect, the invention relates to a coating film formed from the coating composition disclosed above.

In yet another aspect, the invention relates to an article having a film at least a part of the surface of the article, wherein the film is formed from the coating composition disclosed above.

In yet further aspect, the invention relates to a method for forming a film at least a part of the surface of an article, comprising the steps of:

(a) contacting at least a part of the surface of the article with the coating composition disclosed above, and
(b) heating the article to react the first silicone fluid with the methylpolysiloxane.

### DETAILED DESCRIPTION

The coating composition of this invention comprises (A) methylpolysiloxane resin, (B) a lubricant package comprising two kind of different siloxane fluids, (C) a catalyst and (D) a solvent.

(A) Methylpolysiloxane Resin

Methylpolysiloxane resin used in the coating composition is a main component of the coating composition and becomes a matrix resin after the composition is cured. The methylpolysiloxane resin has an average unit formula disclosed below.

(MeₐSiO)ₐ(MeSiO_{3/2})_{b}(O_{1/2}R¹)_{c}

In the formula, Me is a methyl group. Both a and b are positive numbers and refer to molar ratio. The sum of a and b is 1. (O_{1/2}R¹) is a remained reactive group. R¹ is a hydrogen atom or an alkyl group having 1 to 4 carbon atoms. Examples of R¹ include hydrogen atom, methyl group, ethyl group, n-propyl group, iso-propyl group, n-butyl group and tert-butyl group. C is a positive number and less than 2.

When R¹ is an alkyl group, (O_{1/2}R¹) is an alkoxy group. Such alkoxy group can be hydrolyzed to hydroxyl group, and become a reactive group. In one embodiment, at least 0.1% of R¹ is a hydrogen atom. Preferably, at least 1% of R¹ is a hydrogen atom. When R¹ is an alkyl group, 10% or less of R¹ is a hydrogen atom. Preferably, 5% or less of R¹ is a hydrogen atom.

Such methylpolysiloxane resin is commercially available from WACKER Chemie AG.

The amount of methylpolysiloxane resin in the coating composition is 50 to 95 weight %, preferably from 60 to 90 weight %, more preferably from 70 to 85 weight % based on the weight of the coating composition.

(B) Lubricant Package

The lubricant package used in the coating composition comprises two kind of different siloxane fluids. The first one is a high viscous reactive silicone fluid while the second one is a low viscous non-reactive silicone fluid.

(B-1) First Silicone Fluid

The first silicone fluid is a reactive silicone fluid and is defined as the following Formula (1).

R²O(Me₂SiO)ₙMe₂SiOR² Formula (1)

In the Formula (1), Me is a methyl group. R² is a hydrogen atom or an alkyl group having 1 to 4 carbon atoms. Examples of R² include a hydrogen atom, a methyl group, an ethyl group, a n-propyl group, a sec-propyl group, n-butyl group and a tert-butyl group. Preferably, R² is a hydrogen atom or a methyl group. At least one of R² is a hydrogen atom. Preferably, at least one of each end of the Formula (1), totally at least two of R², are hydrogen atoms. n is a number from 100 to 300, preferably from 200 to 300.

The viscosity of the first silicone fluid is 10,000 centistokes or more. Preferably, the viscosity of the first silicone fluid is 15,000 centistokes or more.

Since at least one of R² is a hydrogen atom, the first silicone fluid can react with the methylpolysiloxane resin during curing step and form a crosslink network in a coating. In addition, since the first silicone fluid has a straight and quite long chain, the first silicone fluid works as a lubricant because of its chain flexibility, thus it contributes good ice-phobic property of the coating.

(B-2) Second Silicone Fluid

The second silicone fluid is a non-reactive silicone fluid and is defined as the following Formula (2).

R³₃Si(OSiMe₂)ₘOSiR³₃ Formula (2)

In the Formula (2), Me is a methyl group. R³ is an alkyl group having 1 to 3 carbon atoms. Examples of R³ include a methyl group, an ethyl group, a n-propyl group and a sec-propyl group. Preferably, R³ is a methyl group. m is a number from 10 to 40, preferably from 10 to 20.

The viscosity of the second silicone fluid is from 100 to 2,000 centistokes, preferably from 100 to 1000 centistokes.

The low viscous non-reactive fluid can be mixed in a coating composition and locates in a domain of the crosslinked network formed by the methylpolysiloxane resin and the first silicone fluid after curing step. If a high viscous non-reactive silicone fluid is used instead of the low viscous non-reactive fluid, the high viscous non-reactive silicone fluid cannot be well dispersed in the coating composition thus it cannot locate discretely in the domain disclosed above. So an obtained coating from the composition does not have a sufficient ice-phobic property.

The total amount of the silicone fluids (i.e. a sum of the first silicone fluid and the second silicone fluid) is from 10 to 50 weight %, preferably from 15 to 40 weight %, more preferably from 15 to 30 weight % based on the weight of the coating composition.

The weight ratio of the first silicone fluid over the second silicone fluid ((B-1)/(B-2)) is from 0.6 to 2.8, preferably from 0.8 to 2.0, more preferably from 1.0 to 1.5.

(C) Catalyst

Catalyst used in the coating composition of the invention is a catalyst for condensation of hydroxyl groups, and form a crosslink structure of methylpolysiloxane resins as well as the first silicone fluid. Any known catalyst can be used. Examples of such catalyst include, but are not limited to, zirconium compound such as zirconium octoate and zirconium acetate, titanium compound such as tetrabutyl titanate, zinc compound such as zinc octoate and zinc acetate and tin compound such as dibutyltin dilaurate.

The amount of catalyst in the coating composition should be sufficient to crosslink silicone matrix resin, but typically is from 0.1 to 4 weight %, preferably from 0.2 to 3 weight %, more preferably from 0.5 to 2 weight % based on the weight of the coating composition.

(D) Solvent

The coating composition of the invention comprises a solvent. Examples of solvent include, but are not limited to, alcohols, esters, ethers, ketones, ether-alcohols, aromatic hydrocarbons, aliphatic hydrocarbons, halogenated hydrocarbons and volatile silicones. Silicone fluid with quite low viscosity can be also used as a solvent.

The amount of solvent in the coating composition is from 50 to 90 weight %, preferably from 60 to 80 weight %, more preferably from 60 to 70 weight % based on the weight of the coating composition.

(E) Filler

The coating composition of the invention can optionally include filler in addition to silicone powder. Examples of such filler include, but are not limited to, silica, borate nitride, zinc oxide, aluminum oxide and titanium dioxide. The particle size of the filler is, preferably from 10 to 300 nanometers, more preferably from 20 to 50 nanometers. When the coating composition comprises such filler, the amount is from 10 to 50 weight %, preferably from 20 to 30 weight % based on the weight of the coating composition.

Other Ingredients

The coating composition of the invention can include other ingredients such as rheology modifier, wetting agent and dispersers these are known to those skilled in the art.

Method for Forming a Coating

The present invention also relates to a method for forming a coating film on the surface of an article. The coating film is formed at least a part of the surface of an article by the following method which comprises two steps.

The first step is (a) contacting at least a part of the surface of the article with the coating composition disclosed above. Any article can be used. Examples of such article include, but are not limited to, rotors and blades of wind turbines, power lines, telecommunications, transportations, air crafts and housewares such as refrigerators, freezer box and ice tray. Any techniques can be used to contacting the surface of the article with the coating composition. Examples of such techniques include dipping, splaying, brushing, roll coating, spin coating and wire coating.

The second step is (b) heating the article to react the first silicone fluid with the methylpolysiloxane. This step is also called as curing step. Two reactions happen during the curing step. One is a reaction between two or more methylpolysiloxane. The hydroxyl groups in methylpolysiloxane condense together and release water. The other is a reaction between the first silicone fluid and methylpolysiloxane, or a condensed methylpolysiloxane. The cross-linking is normally occurred by heat under a catalyst. The conditions such as temperature or heating time is vary and are known to those skilled in the art, but one example is from 180 to 270 degrees C. for 0.5 to 2 hours.

Coating Film

The coating composition of the present invention can provide a hard coating with quite low adhesion to ice. The hardness of the coating film is 2H or more by pencil hardness method. The thickness of the coating film is preferably from 3 to 20 micrometers, more preferably from 5 to 15 micrometers.

### EXAMPLES

The raw materials disclosed in Table 1 were used to prepare samples in Examples and Comparative Examples.

TABLE 1

| | Description | Supplier |
|---|---|---|
| A1 | methyl silicone resin | WACKER |
| | | Chemie AG |
| B1-1 | Silanol terminated polydimethylsiloxane, | Dow Corning |
| | viscosity is 15,000 cst or more | |
| B2-1 | Tri-methyl terminated polydimethyl siloxane, | Dow Corning |
| | Silicone fluid with 100 cst viscosity | |
| B2-2 | Tri-methyl terminated polydimethyl siloxane, | Dow Corning |
| | Silicone fluid with 350 cst viscosity | |
| B2-3 | Tri-methyl terminated polydimethyl siloxane, | Dow Corning |
| | Silicone fluid with 1,000 cst viscosity | |
| Other | Tri-methoxy and tri-methyl terminated | Dow Corning |
| fluid 1 | polydimethylsiloxane. (One-end reactive fluid), | |
| | Mw is less than 2,000. Viscosity is 25 cst to | |
| | 40 cst. | |
| Other | Tri-methoxy and tri-methyl terminated | Dow Corning |
| fluid 2 | polydimethylsiloxane (One-end reactive fluid), | |
| | Mw is less than 8,000. Viscosity is 130 cst | |
| Other | Bis-(tri-methoxy) terminated | Dow Corning |
| fluid 3 | polydimethylsiloxane. (Two-end reactive fluid), | |
| | Mw is 25300, Viscosity is 400 mPa · s | |
| C1 | Zirconium octoate | Aldrich |
| D1 | ISOPER E (Iso paraffin). | Exxon Mobil |
| D2 | Hexamethyldisiloxane solvent | Dow Corning |

### Examples 1 to 4 and Comparative Examples 1 to 7

The law materials listed in Tables 2 and 3 were homogeneously mixed by shaking for 30 minutes at room temperature. 0.6 ml of each solution was blade coated on aluminum panel and heated to cure the composition, at 200 degrees C. for 1. Dry film thickness was analyzed by the film thickness gauge, Surfix® FN2.2, made from PHYNIX GmbH&Co.KG. Pencil hardness were also evaluated.

### Ice Adhesion Testing Method:

Prepared plastic caps (diameter is 4.3 cm) and aluminum plates. The plastic cap is put on the aluminum plate, then the plate with the plastic cap was cooled to form ice on the surface of the aluminum plate under −20 degrees C. for 24 hours. The plate with plastic cap was fixed by a clamp in environmental chamber set at −20 degrees C. The cap was pushed by a metal probe in parallel direction with the plate surface, with speed of 1 mm/minutes. The maximum force (F·N) was recorded to isolate the cap from the surface of the plate. Then ice adhesion strength was calculated by the following equation: t=F/1.45 (kPa)

The result are also added in Tables 2 and 3. Ice adhesion test was repeated for 25 cycles and record the result as 25th cycle.

TABLE 2

| | Examples | | | |
|---|---|---|---|---|
| | 1 | 2 | 3 | 4 |
| A1 | 3.6 | 3.6 | 3.6 | 3.6 |
| B1-1 | 0.2 | 0.2 | 0.2 | 0.2 |
| B2-1 | 0.2 | 0 | 0.1 | 0 |
| B2-2 | 0 | 0.2 | 0.1 | 0 |
| B2-3 | 0 | 0 | 0 | 0.2 |
| C1 | 0.08 | 0.08 | 0.08 | 0.08 |
| D1 | 5.2 | 5.2 | 5.2 | 5.2 |
| D2 | 1.0 | 1.0 | 1.0 | 1.0 |
| Film thickness (micrometers) | 15 | 15 | 15 | 15 |
| Hardness | 3H | 3H | 3H | 3H |
| Ice adhesion as prepared/kPa | 5.5 | 8.5 | 0.5 | 2.1 |
| Ice adhesion after 25 cycles/kPa | 6.5 | 8.6 | 1.4 | 3.1 |
| Fluid Ratio (B-1)/(B-2) | 1 | 1 | 1 | 1 |

TABLE 3

| | Comparative examples | | | | | | |
|---|---|---|---|---|---|---|---|
| | 1 | 2 | 3 | 4 | 5 | 6 | 7 |
| A1 | 3.6 | 3.6 | 3.6 | 3.6 | 3.6 | 3.6 | 3.6 |
| B1-1 | 0.2 | — | 0.3 | 0.2 | 0.2 | 0.2 | 0.2 |
| B2-1 | 0 | 0.2 | 0.1 | 0.4 | 0 | 0 | 0 |
| Other fluid 1 | 0 | 0 | 0 | 0 | 0.2 | 0 | 0 |
| Other fluid 2 | 0 | 0 | 0 | 0 | 0 | 0.2 | 0 |
| Other fluid 3 | 0 | 0 | 0 | 0 | 0 | 0 | 0.2 |
| C1 | 0.08 | 0.08 | 0.08 | 0.08 | 0.08 | 0.08 | 0.08 |
| D1 | 5.2 | 5.2 | 5.2 | 5.2 | 5.2 | 5.2 | 5.2 |
| D2 | 1.0 | 1.0 | 1.0 | 1.0 | 1.0 | 1.0 | 1.0 |
| Film thickness | 15 | 15 | 15 | 15 | 15 | 15 | 15 |
| (micrometers) | | | | | | | |
| Hardness | 4H | 4H | 4H | 2H | H | 32H | 23H |
| Ice adhesion as | 30.0 | Oil | Oil | Oil | 28.0 | 30.0 | 35.0 |
| prepared/kPa | | bleeding | bleeding | bleeding | | | |
| Ice adhesion | >60.0 | NA | NA | NA | NA | NA | NA |
| after 25 | | | | | | | |
| cycles/kPa | | | | | | | |
| Fluid Ratio | — | — | 3 | 0.5 | — | — | — |
| (B-1)/(B-2) | | | | | | | |

1. A coating composition comprising:
(A) 50 to 95 weight % of a methylpolysiloxane resin;
(B) 10 to 50 weight % of a silicone fluid mixture comprising (B1) a first silicone fluid and (B2) a second silicone fluid represented by the following formulas,
the first silicone fluid (B1) having the general formula (1)
R²O(Me₂SiO)ₙMe₂SiOR² (1)
wherein Me is a methyl group, R² is a hydrogen atom or an alkyl group having 1 to 4 carbon atoms, n is a number from 100 to 300, and the viscosity of the first silicone fluid (B1) is 10,000 centistokes or more,
the second silicone fluid (B2) having the general formula (2)
R³₃Si(OSiMe₂)ₘOSiR³₃ (2)
wherein Me is a methyl group, R³ is an alkyl group having 1 to 3 carbon atoms, m is a number from 10 to 40, and the viscosity of the second silicone fluid (B2) is from 100 to 2,000 centistokes;
(C) 0.1 to 4 weight % of a catalyst; and
(D) 50 to 90 weight % of a solvent;
wherein the weight ratio of the silicone fluids ((B-1)/(B-2)) is from 0.6 to 2.8.

2. The coating composition of claim 1, wherein the catalyst is selected from the group consisting of zirconium octoate, zirconium acetate, zinc octoate, zinc acetate, tetrabutyl titanate, and dibutyltin dilaurate.

3. The coating composition of claim 1, further comprising (E) a filler.

4. The coating composition of claim 3, wherein the particle size of the filler (E) is from 10 to 300 micrometers.

5. A coating film formed from the coating composition of claim 1.

6. An article having a surface and a film disposed on at least a portion of the surface, wherein the film is formed from the coating composition of claim 1.

7. A method for forming a film on a surface of an article, the method comprising the steps of:
(a) contacting the surface of the article with the coating composition of claim 1; and
(b) heating the article to react the first silicone fluid (B1) with the methylpolysiloxane resin (A).
